(19) United States
(12) Patent Application Publication
(10) Pub. No.: US 2021/0125520 A1
(43) Pub. Date: Apr. 29, 2021

(54) COGNITIVE TRAINING AND PLAY DEVICE, FOR FAMILIARIZING SQUARES, SQUARE ROOTS AND PRIME NUMBERS

(71) Applicant: Pratima PATIL, Mumbai (IN)

(72) Inventor: Pratima PATIL, Mumbai (IN)

(21) Appl. No.: 17/052,194

(22) PCT Filed: Nov. 15, 2019
(86) PCT No.: PCT/IN2019/050846

§ 371 Date: Nov. 1, 2020

(30) Foreign Application Priority Data
Dec. 8, 2018 (IN) 201821021607

(51) Int. Cl. G09B 19/02

(52) U.S. Cl. CPC G09B 19/02

(57) ABSTRACT

Present invention relates to a cognitive training device for familiarizing squares, square roots and prime numbers. The present invention discloses a cognitive training device for familiarizing squares, square roots and prime numbers comprising a playing board and an instrument to generate random numbers. The use of this device increases the visuospatial ability of the user and makes learning possible for even individuals suffering from dyscalculia. The user of the cognitive training device disclosed in the present invention will be able to familiarize with numbers, similarities and their interrelations without a wide range of basic abilities and effort that is generally needed to understand mathematical concepts.

### TECHNICAL FIELD

Present invention relates to a cognitive training and play device for familiarizing squares, square roots and prime numbers.

### BACKGROUND OF THE INVENTION

Mathematics is a complex subject including different domains such as arithmetic, arithmetic problem solving, geometry, algebra, probability, statistics and calculus that requires mobilizing a variety of basic abilities associated with the sense of quantity, symbols decoding, memory, visuospatial capacity and logic. Students with difficulties in any of these abilities or in their coordination always experience mathematical learning difficulties.

Further, young children between the ages of 2-10, are in the process of developing these essential skills, thus they find simple mathematical concepts like familiarizing numbers, squares of numbers, square roots and prime numbers difficult.

It may, therefore, be noted; mathematics problem-solving requires certain skills to be developed before conceptual knowledge may be disseminated. However, large numbers of students have not acquired the basic skills. One such skill is to identify numbers and know the interrelations. Thus, there is a need in the prior art to design cognitive training devices to disseminate mathematical skills more effectively.

The present invention discloses one such cognitive training and play device for familiarizing squares, square roots and prime numbers comprising a playing board and an instrument to generate random numbers. It also has a set of differentiating marker pieces for identifying players using the said cognitive training and play device. Examples of the differentiating marker pieces are distinctly coloured flags, coins or game pieces.

The use of this cognitive training and play device increases the visuospatial ability. Visuospatial ability refers to a person's capacity to identify visual and spatial relationships among two connected numbers or objects. Visuospatial ability is traditionally being used to disseminate knowledge to children in fields other than mathematics. The best example being alphabets are always linked to the corresponding object while teaching a child. For example: A for Apple. If mathematical concepts were taught with a similar approach, it would not burden the young mind and learning would be interesting. Thus, there is a need for various innovative cognitive training devices for dissemination of mathematical concepts.

The user of the cognitive training and play device disclosed in the present invention will be able to familiarize with the numbers, similarities and their interrelations without a wide range of basic abilities and effort.

Also, children with learning and attention issues may struggle with math for a variety of reasons. For example, individuals with dyscalculia do not have a strong number sense. The trouble with working memory, visual processing, and other issues can play a role to aggravate the problems faced by them. The cognitive training and play device disclosed in the present invention is very helpful to train such children without undue pressure and anxiety.

### SUMMARY OF THE INVENTION

The present invention discloses a cognitive training device for familiarizing squares, respective square root and prime numbers, comprising a playing board and an instrument to generate random numbers. It also has a set of differentiating marker pieces for identifying players using the said cognitive training and play device. The use of this cognitive training and play device increases the visuospatial ability of the user and makes learning possible for even individuals suffering from dyscalculia.

The invention relates to disclosing a cognitive training and play device wherein, the squares, respective square roots and prime numbers will be familiarized. In this approach, the user has access to the teaching without being explicitly taught. Therefore, it eliminates the need for rote learning. With the use of the disclosed cognitive training and play device more meaningful learning, associative learning, and active learning is possible.

### BRIEF DESCRIPTION OF THE DRAWING

FIG. 1: is a view of the playing surface of a rectangular playing board (2) marked thereon a matrix of n×n dividing the said playing board into n² subunits (21). Further explaining FIG. 1, the present invention discloses a cognitive training and play device (1), for familiarizing squares, square roots and prime numbers by the players comprising a rectangular playing board (2) for use as a playing surface by the players. The rectangular playing board (2) is marked thereon a matrix of n×n dividing the said playing board into n² subunits (21) ranging from [1, 1] to [n, n]. In FIG. 1, the array position [x, y] wherein x is the row number and y is the column number is shown. The said matrix is a two-dimensional square matrix wherein the number of rows vary from 1 to n and the number of columns also varies from 1 to n.

FIG. 2: is a view of the center subunit marked by number 1 positioned on a subunit (23) and corresponding end subunit marked by number n²positioned on subunit (26) for an matrix n ×n wherein n is even and the path is clockwise.

FIG. 3: is a view of the center subunit marked by number 1 positioned on a subunit (23) and corresponding end subunit marked by number n²positioned on subunit (26) for a matrix n×n wherein n is even, and the path is anticlockwise.

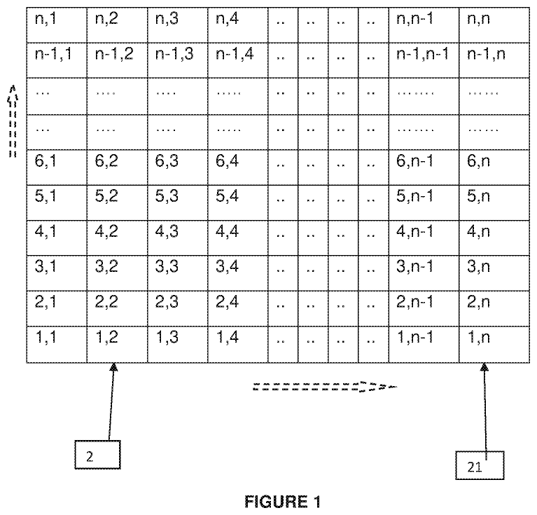

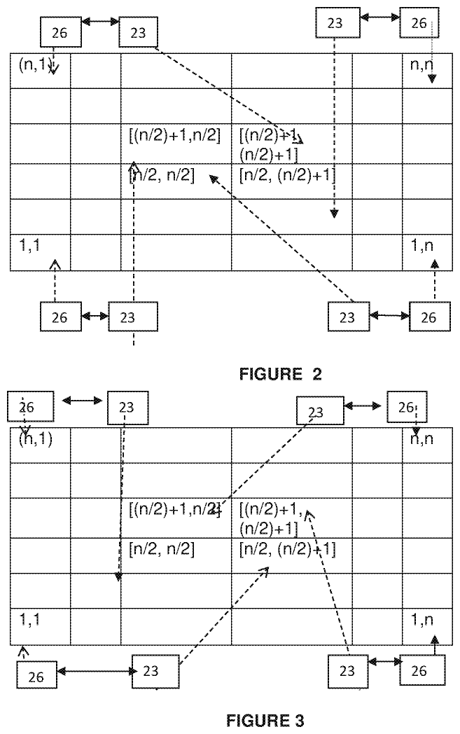

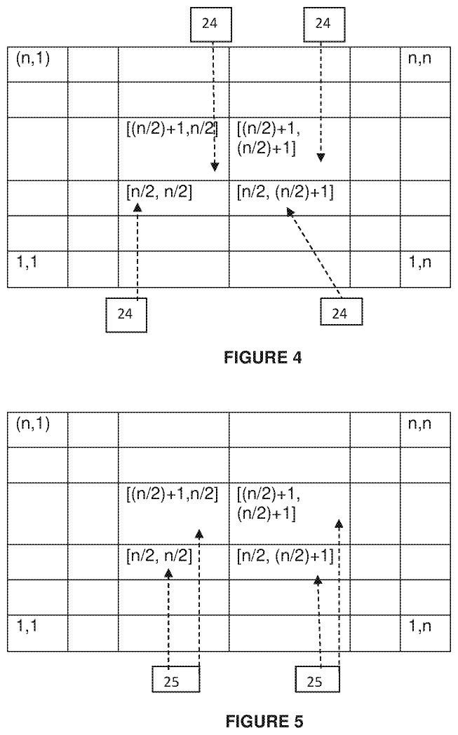

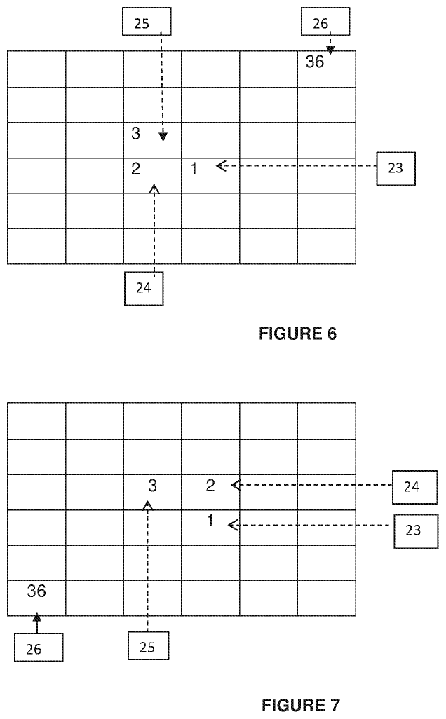

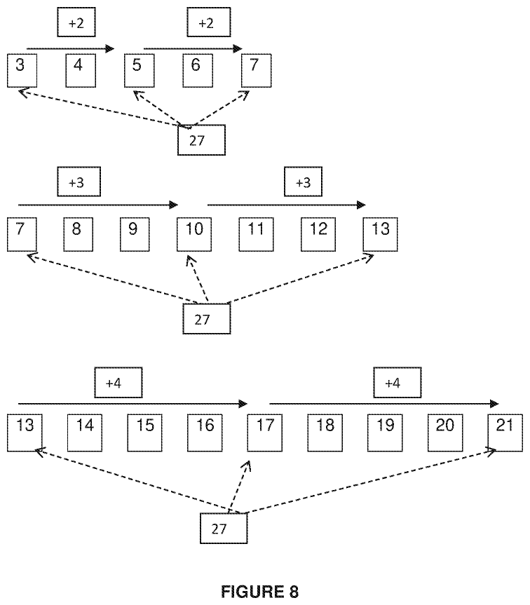

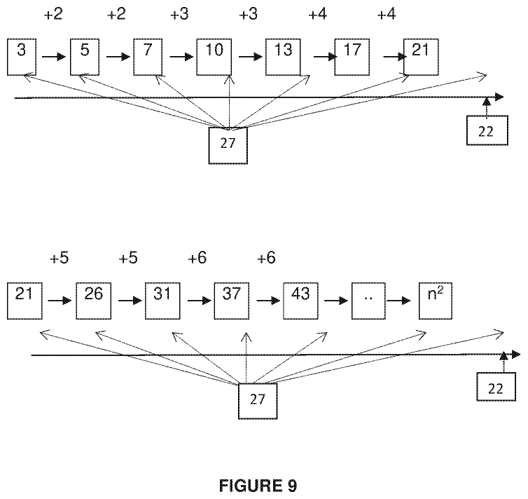

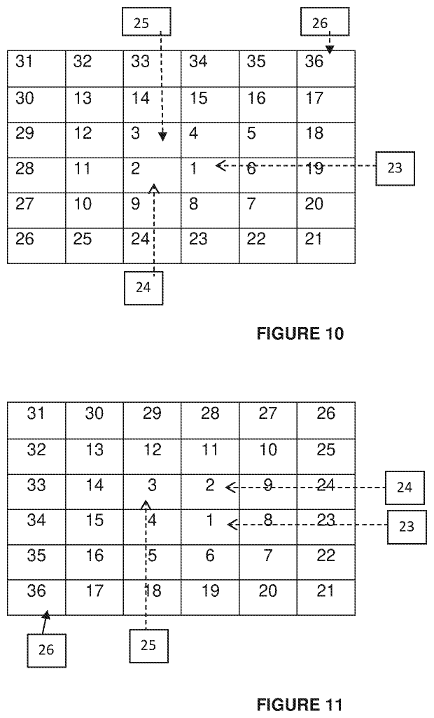

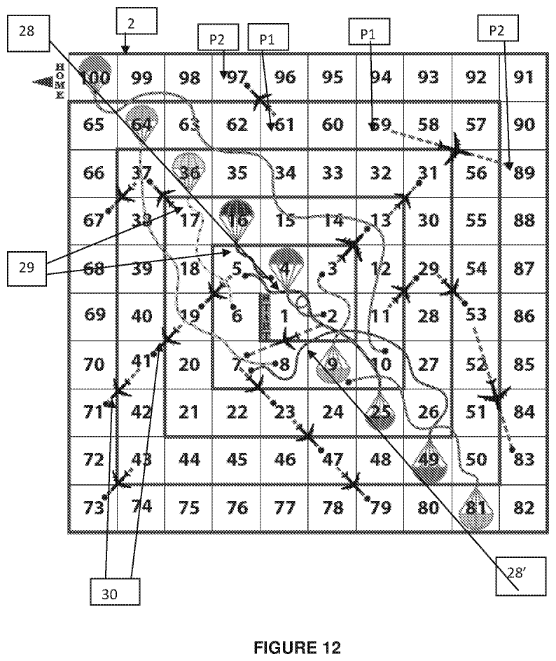

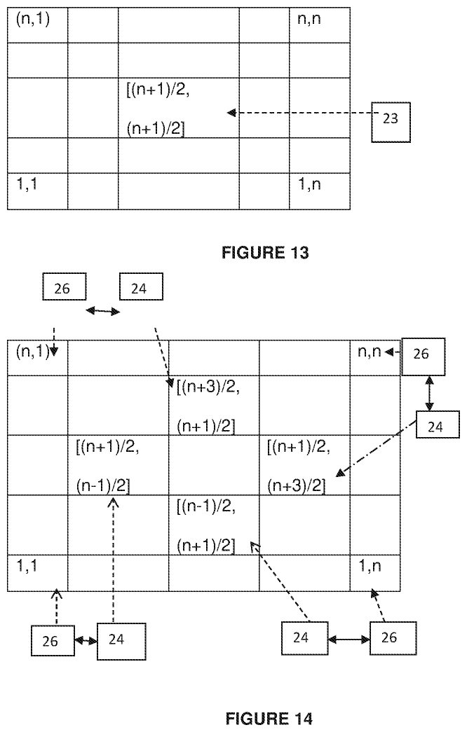

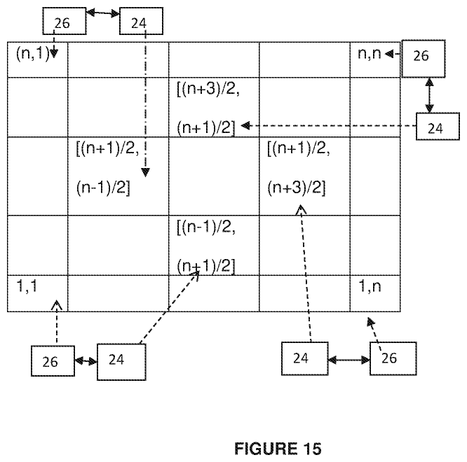

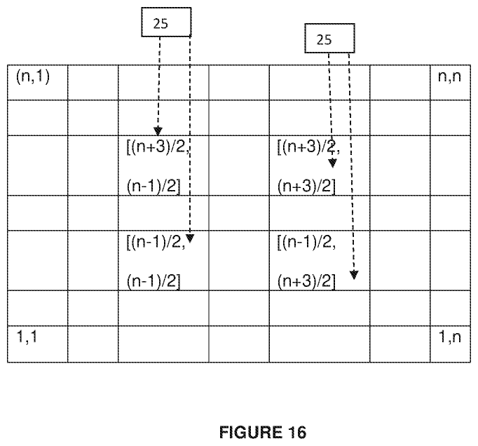

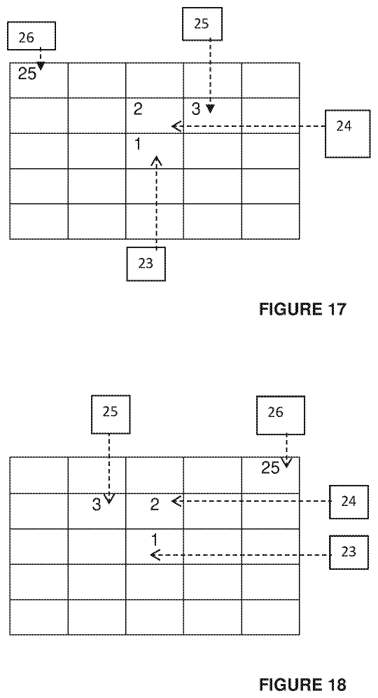

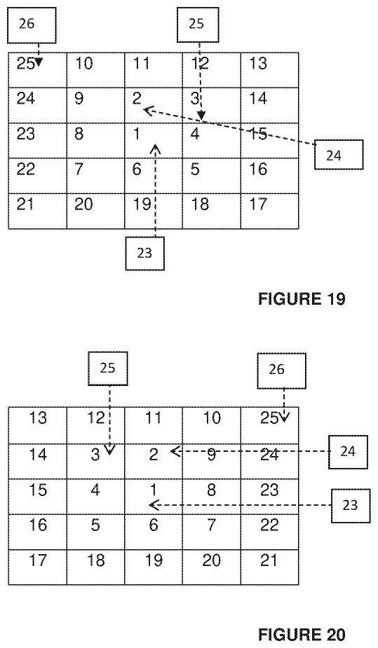

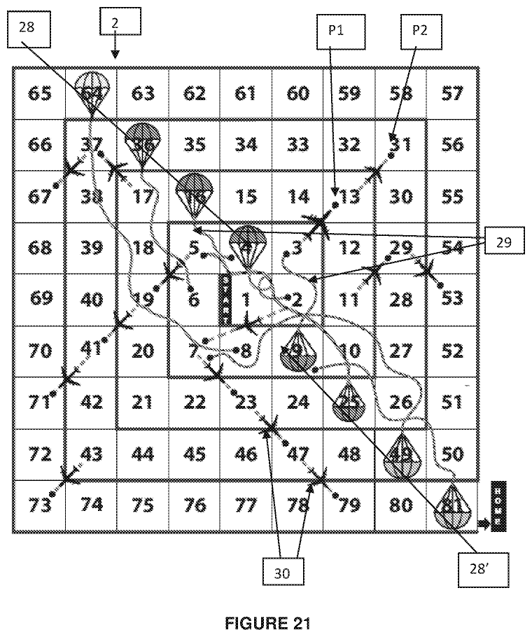

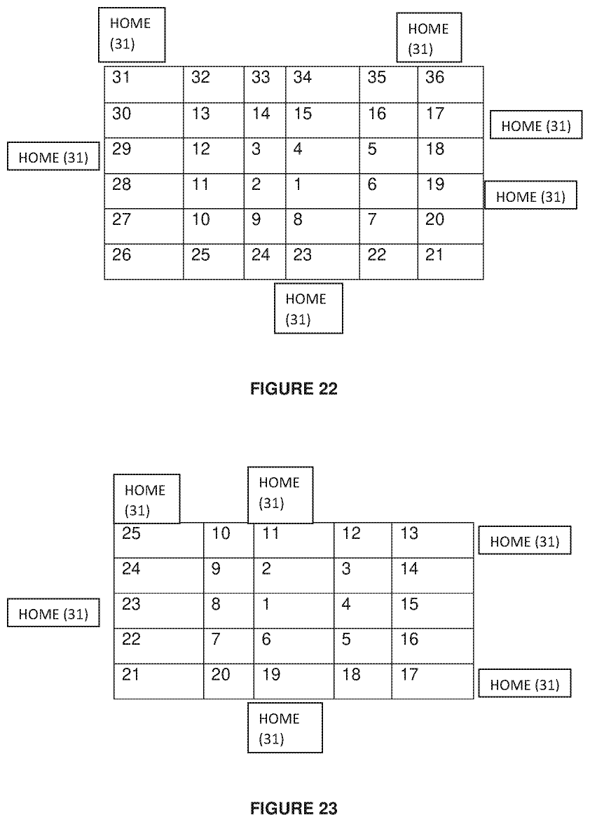

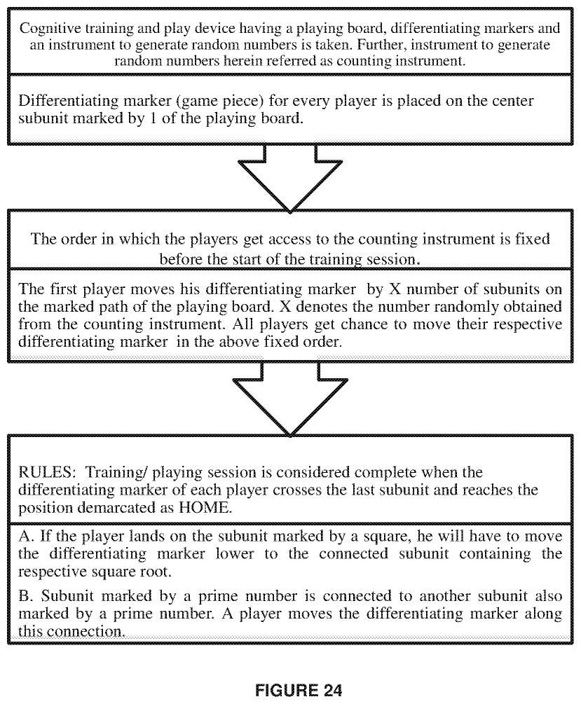

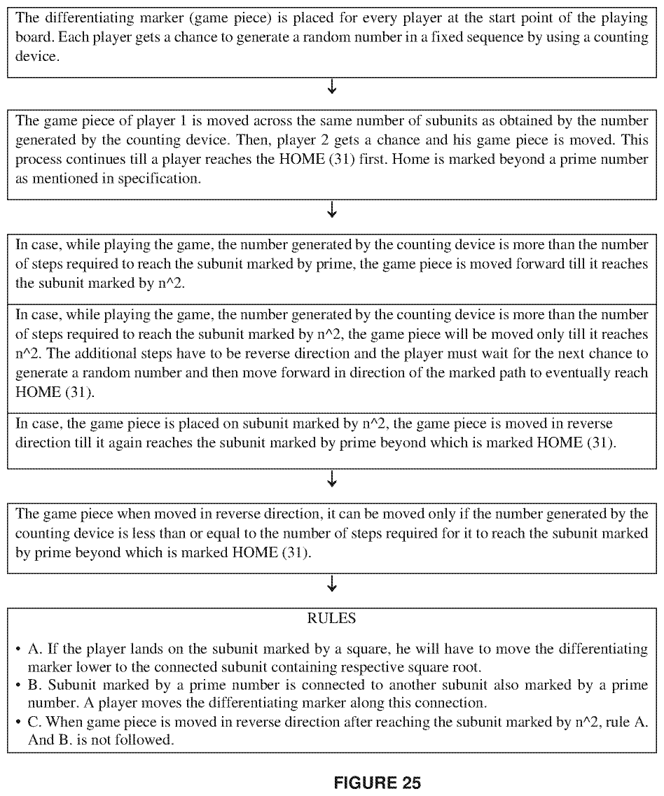

Further explaining FIGS. 2 and 3, the rectangular playing board is also marked thereon anticlockwise or clockwise path (22) starting from a center marked by number 1 positioned on a subunit (23) and ending on a corner marked by number n² positioned on another subunit (26). When the path is marked in clockwise direction then the path start is positioned on a subunit (23) selected from [n/2, n/2], [(n/2)+1, n/2], [n/2, (n/2)+1] and [(n/2)+1, (n/2)+1] and the path end is positioned on a corresponding subunit (26) positioned at [1,n], [1,1], [n,n] and [n,1] respectively. Thus, the center subunit (23) and the corresponding end subunit (26) is shown in FIG. 2 for an n×n matrix wherein n is even, and the path is clockwise. When the path is marked in anticlockwise direction then the path start is positioned on a subunit (23) selected from [n/2, n/2], [(n/2)+1, n/2], [n/2, (n/2)+1] and [(n/2)+1, (n/2)+1] and the path end is positioned on the a subunit (26) positioned at [n,1], [n, n], [1,1] and [1,n] respectively. Thus, the center subunit (23) and the corresponding end subunit (26) is shown in FIG. 3 for an n×n matrix wherein n is even, and the path is anticlockwise.

FIG. 4: is a view of the subunit marked by number 2 positioned on a subunit (24) for a matrix n×n wherein n is even.

FIG. 5: is a view of the subunit marked by number 3 positioned on a subunit (25) for a matrix n×n wherein n is even. Further explaining FIGS. 4 and 5, after marking the centre subunit (23) by 1, number 2 is essentially marked on a subunit (24) selected from [n/2, n/2], [(n/2)+1, n/2], [n/2, (n/2)+1] or [(n/2)+1, (n/2)+1] excluding the subunits (23). The position of subunit marked by 2 is shown in FIG. 4. Further, number 3 is essentially marked on a subunit (25) selected from [n/2, n/2], [(n/2)+1, n/2], [n/2, (n/2)+1] and [(n/2)+1, (n/2)+1] excluding the subunits (23) and subunit marked by 2. The position of subunit marked by 3 is shown in FIG. 5. The positions shown in FIGS. 4 and 5 are suitable for all n×n matrix wherein n is even, and the path may be clockwise or anticlockwise.

FIG. 6: is a view of position of subunit (23) marked by 1, subunit (24) marked by 2, and subunit (25) marked by 3 for a 6×6 matrix wherein path is clockwise. It also shows the corresponding end subunit (26) marked by 36.

FIG. 7: is a view of position of subunit (23) marked by 1, subunit (24) marked by 2, and subunit (25) marked by 3 for a 6×6 matrix wherein path is anti-clockwise. It also shows the corresponding end subunit (26) marked by 36. Further, after positioning the subunits marked with the numbers 1 to 3 on the rectangular playing board, the path turns 90 degrees at several subunits (27) to follow either clockwise or anticlockwise direction till reaching its ending subunit (26). The turnings are shown in FIGS. 8-9.

FIG. 8: is a view of subunits (27) at which the marked clockwise or anticlockwise path (22) turns by 90 degrees in the chosen direction of the path. The turns are at regular intervals that follow a certain pattern.

FIG. 9: further illustrates the pattern shown in FIG. 8. Further explaining FIG. 8, the first turn being at a subunit denoted by 3 and travel further till 2 subunits, then at a subunit denoted by 5 and travel further till 2 subunits, and subsequently take two consecutive turns at every three subunits, then at every four subunits, and follows this two times turning pattern sequentially for five, six and so on subunits while travelling further and reaching to the ending subunit (26). This is shown in FIG. 8 and FIG. 9. The subunits at which the path turns is denoted as (27). Thus, n can be even or odd. As marked in FIGS. 8 and 9, the turns are at subunits (27) marked by numbers following a series of 3, 5, 7, 10, 13, 17, 21, . . . , n² wherein the difference between the subsequent values of the said series follow the pattern of +2, +2, +3, +3, +4, +4, . . . .

FIG. 10: is a view of the playing surface of a rectangular playing board (2) marked thereon a matrix of 6×6 dividing the said playing board into 36 subunits wherein every subunit is marked by a number in accordance to the embodiment of the present invention and the path is clockwise.

FIG. 11: is a view of the playing surface of a rectangular playing board (2) marked thereon a matrix of 6×6 dividing the said playing board into 36 subunits wherein every subunit is marked by a number in accordance to the embodiment of the present invention and the path is anticlockwise.

FIG. 12: is a view of a rectangular playing board (2) of a cognitive training device as disclosed in the present invention with matrix 10×10. Further explaining FIG. 12, the FIG. 12 shows two parallel diagonals (28, 28′) incorporating within them the squares of even numbers and squares of odd numbers. The diagonals subunits marked by squares are identified and connected to its square root. Further, the subunits on the diagonals (28, 28′) are connected to its respective square root wherein subunit marked by square is the starting point of connection and subunit marked by respective square root is the end point of the connection. Thus, pairs of square and square root (29) by connecting a subunit marked with square to a subunit marked with its respective square root are shown. Also, prime numbers (30) identified thereon by connecting at least two subunits marked with the subunits marked with prime number. The said connection is made by connecting a subunit marked by a lower value prime number (P1) to a subunit marked by a higher value prime number.

FIG. 13: is a view of the center subunit marked by number 1 positioned on a subunit (23) for a matrix n×n wherein n is odd number.

FIG. 14: is a view of the subunit marked by number 2 positioned on a subunit (24) and corresponding end subunit marked by number n²positioned on subunit (26) for a matrix n×n wherein n is odd number and the path is clockwise.

FIG. 15: is a view of the subunit marked by number 2 positioned on a subunit (24) and corresponding end subunit marked by number n²positioned on subunit (26) for a matrix n×n wherein n is odd number and the path is anti-clockwise.

FIG. 16: is a view of the subunit marked by number 3 positioned on a subunit (25) for a matrix n×n wherein n is odd number and the path is clockwise.

FIG. 17: is a view of position of subunit (23) marked by 1, subunit (24) marked by 2, and subunit (25) marked by 3 for a 5×5 matrix wherein path is clockwise. It also shows the corresponding end subunit (26) marked by 25.

FIG. 18: is a view of position of subunit (23) marked by 1, subunit (24) marked by 2, and subunit (25) marked by 3 for a 5×5 matrix wherein path is anticlockwise. It also shows the corresponding end subunit (26) marked by 25.

FIG. 19: is a view of the playing surface of a rectangular playing board (2) marked thereon a matrix of 5×5 dividing the said playing board into 25 subunits wherein every subunit is marked by a number in accordance to the embodiment of the present invention and the path is clockwise.

FIG. 20: is a view of the playing surface of a rectangular playing board (2) marked thereon a matrix of 5×5 dividing the said playing board into 25 subunits wherein every subunit is marked by a number in accordance to the embodiment of the present invention and the path is anticlockwise.

FIG. 21: is a view of a rectangular playing board (2) of a cognitive training device as disclosed in the present invention with matrix 9×9.

FIG. 22: is position of HOME (31). HOME (31) denotes the end of the playing session. The position of HOME (31) may vary. Generally, the Home (31) is marked beyond the subunit marked by n² and HOME (31) is not a part of the matrix. In other cases, HOME (31) continues to not form a part of the matrix and can be marked adjacent to on any subunit marked by a prime number that is essentially positioned at [x, 1], [x, n], [1, y], [n, y] wherein x and y represent the row number and column number respectively and can vary from 1 to n. The position of HOME (31) in the above cases may be further illustrated using FIGS. 23 and 24. FIG. 23, is the position of HOME (31) for 6×6 matrix.

FIG. 23: is position of HOME (31) for 5×5. HOME (31) denotes the end of the playing session for 5×5 matrix.

FIG. 24: is flowchart of the standard operating procedure for training and playing by using the cognitive training and play device when HOME is marked on the subunit (26). The procedure of using the marked playing board, differentiating marker pieces and an instrument to generate numbers is disclosed.

FIG. 25: is flowchart of the standard operating procedure for training and playing by using the cognitive training and play device when HOME (31) continues to not form a part of the matrix and can be marked adjacent to on any subunit marked by a prime number that is essentially positioned at [x, 1], [x, n], [1, y], [n, y] wherein x and y are the row numbers and can vary from 1 to n. The procedure of using the marked playing board, differentiating marker pieces and an instrument to generate numbers is disclosed

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity; but include the general class of which a specific example may be used for illustration. The terminology herein is used to describe specific embodiments of the invention, but their usage, does not delimit the invention, except as outlined in the claims.

The present invention discloses a cognitive training and play device, for familiarizing squares, square roots and prime numbers, comprising a rectangular playing board (2) for use as a playing surface by the players, and an instrument to generate random numbers. It also has a set of differentiating marker pieces for identifying players of the said cognitive training and play device.

In one aspect of the present invention, a playing board with a matrix of n×n is disclosed wherein n is an even number and n² is the respective square of the even number n. Hence, the matrix has n²subunits ranging from [1, 1] to [n, n] and is marked on the playing board. The said playing board may be rectangular. However, it may be preferred that the playing board is a square and each of the n²subunits is similar in size. In such case, it will be more visually impacting thereby giving enhanced cognitive training to familiarize primes, squares and their respective square root.

Further, there is an anticlockwise or clockwise path that starts from the center subunit (23) marked by 1 to the end subunit (26) marked by n².

HOME (31) denotes the end of the playing session. The position of HOME (31) may vary. Generally, the Home (31) is marked beyond the subunit marked by n² and HOME (31) is not a part of the matrix. In other cases, HOME (31) continues to not form a part of the matrix and can be marked adjacent to on any subunit marked by a prime number that is essentially positioned at [x, 1], [x, n], [1, y], [n, y] wherein x and y are the row numbers and can vary from 1 to n. The position of HOME (31) in the above cases, may be further illustrated using FIGS. 23 and 24.

The center subunit (23) of rectangular playing of this preferred embodiment is selected from [n/2, n/2], [(n/2)+1, n/2], [n/2, (n/2)+1] and [(n/2)+1, (n/2)+1]. Further number 2 is essentially marked on a subunit (24) selected from [n/2, n/2], [(n/2)+1, n/2], [n/2, (n/2)+1] and [(n/2)+1, (n/2)+1]and excludes the subunit (23) marked by 1. Further number 3 is essentially marked on a subunit (25) selected from [n/2, n/2], [(n/2)+1, n/2], [n/2, (n/2)+1] and [(n/2)+1, (n/2)+1]and excludes subunit marked by 1 and 2.

After positioning the subunits marked with the numbers 1 to 3 on the board the path (22) turns 90 degrees at several subunits (27) to follow either clockwise or anticlockwise direction till reaching its ending subunit (26). As denoted in FIG. 8 and FIG. 9, the first turn being at a subunit denoted by 3 and travel further till 2 subunits, then at a subunit denoted by 5 it turns by 90 degrees in the chosen direction and travel further till 2 subunits, and subsequently take two consecutive turns at every three subunits, then at every four subunits, and follows this two times turning pattern sequentially for five, six and so on subunits while travelling further and reaching to the ending subunit (26).

It may be noted that when the path is marked in clockwise direction then the path start is positioned on a subunit (23) selected from [n/2, n/2], [(n/2)+1, n/2],[n/2, (n/2)+1] and [(n/2)+1, (n/2)+1] and the path end is positioned on a corresponding subunit (26) positioned at [1,n], [1,1],[n,n] and [n,1] respectively, and when the path is marked in anticlockwise direction then the path start is positioned on a subunit (23) selected from [n/2, n/2], [(n/2)+1, n/2], [n/2, (n/2)+1] and [(n/2)+1, (n/2)+1] and the path end is positioned on the a subunit (26) positioned at [n,1], [n, n], [1,1] and [1,n].

Once all subunits ranging from 1 to n² are marked and mentioned thereon a particular number that is sequentially obtained, two parallel diagonals (28,28′) incorporating within them the squares of even numbers ranging from 2 to n and squares of odd numbers ranging from 1 to (n−1) respectively are identified and marked by an object.

Further, the subunits marked by a square is connected to a subunit marked by its respective square root, more particularly by using a parachute connected to a line wherein the subunit marked by the square is marked by the parachute and the line ends at the subunit is marked by its respective square root.

Further, all subunits marked by a prime number lesser than n*n is connected to at least one subunit containing another prime number. Procedure for making this connection is that subunits marked with prime number that form diagonals on the rectangular playing board (2), are preferably connected first. Later, the remaining subunits marked by prime numbers that do not form diagonals on the playing board are connected to the nearest prime. These connections help mind-mapping or visual mapping and therefore a numerically challenged child can also recognize the prime numbers.

Thus, it may be noted that multiple pairs of prime numbers (30) are identified by first marking the prime numbers identified thereon by connecting at least two subunits marked with a prime number. Marking the subunit with lower value prime number (P1) as the starting point of connection, marking the subunit with higher value prime number (P2) as the end point of the connection, and connecting them together by an object, a dotted or straight line or any combination thereof. In one preferred embodiment, the object is an image of an aeroplane.

In another aspect of the present invention, a playing board with a matrix of n×n is disclosed wherein n is an odd number and n² is the respective square of the odd number n. Hence, the matrix has n²subunits ranging from [1, 1] to [n, n] and is marked on the playing board. The said playing board may be rectangular. However, it may be preferred that the playing board is a square and each of the n×n subunits is similar. In this case, it will be more visually impacting thereby giving enhanced cognitive training to familiarize with primes, squares and their respective square roots.

Further, there is an anticlockwise or clockwise path that starts from the center subunit marked by 1 to the last subunit marked by n².

HOME (31) denotes the end of the playing session. The position of HOME (31) may vary. Generally, the Home (31) is marked beyond the subunit marked by n² and HOME (31) is not a part of the matrix. In other cases, HOME (31) continues to not form a part of the matrix and can be marked adjacent to on any subunit marked by a prime number that is essentially positioned at [x, 1], [x, n], [1, y], [n, y] wherein x and y are the row numbers and can vary from 1 to n. The position of HOME (31) in the above cases, may be further illustrated using FIGS. 23 and 24.

Center subunit (23) is [n+1/2, n+1/2]. This subunit is marked thereon by the number 1. Further, number 2 is essentially marked on a subunit selected from [(n+3)/2, (n+1)/2], [(n+1)/2, (n+3)/2], [(n−1)/2, (n+1)/2] or [(n+1)/2, (n−1)/2]. Also, number 3 is essentially marked on a subunit selected from[(n+3)/2, (n+3)/2], [(n−1)/2, (n+3)/2], [(n−1)/2, (n−1)/2] or [(n+3)/2, (n−1)/2] and is also in the chosen path.

After positioning the subunits marked with the numbers 1 to 3 on the board the path turns 90 degrees at several subunits (27) to follow either clockwise or anticlockwise direction till reaching its ending subunit (26). The first turn being at a subunit denoted by 3 and travel further till 2 subunits, then at a subunit denoted by 5 it turns by 90 degrees in the chosen direction and travel further till 2 subunits, and subsequently take two consecutive turns at every three subunits, then at every four subunits, and follows this two times turning pattern sequentially for five, six and so on subunits while travelling further and reaching to the ending subunit (26).

It may be noted that when the path is marked in clockwise direction then the path start is positioned on a subunit (23) [n+1/2, n+1/2]. The number 2 is essentially marked on a subunit selected from [(n+3)/2, (n+1)/2], [(n+1)/2, (n+3)/2], [(n−1)/2, (n+1)/2] and [(n+1)/2, (n−1)/2]. Then, said path ends at corresponding subunit (26) positioned at [n,1], [n,n], [1,n] and [1,1] respectively.

It may also be noted that when path is marked in anticlockwise direction then the path start is positioned on a subunit (23) [n+1/2, n+1/2], and number 2 is essentially marked on a subunit selected from [(n+3)/2, (n+1)/2], [(n+1)/2, (n+3)/2], [(n−1)/2, (n+1)/2] and [(n+1)/2, (n−1)/2]. Then, said path ends at corresponding subunit (26) positioned at [n,n], [1,n], [1,1] and [n,1] respectively.

Once all subunits ranging from 1 to n² are marked and mentioned thereon a particular number that is sequentially obtained, two parallel diagonals (28,28′) incorporating within them the squares of even numbers ranging from 2 to n and squares of odd numbers ranging from 1 to (n−1) respectively are identified and marked by an object. Further, the subunits marked by a square is connected to a subunit marked by its respective square root, more particularly by using a parachute connected to a wire wherein the subunit marked by the square is marked by the parachute and the wire ends at the subunit marked by its respective square root.

Further, all subunits marked by a prime number lesser than n*n is connected to at least one subunit containing another prime number. Procedure for making this connection is that subunits marked with prime number that form diagonals on the rectangular playing board (2), are preferably connected first. Later, the remaining subunits marked by prime numbers that do not form diagonals on the playing board are connected to the nearest prime. These connections help mind-mapping or visual mapping and therefore a numerically challenged child can also recognize the prime numbers.

Thus, it may be noted that multiple pairs of prime numbers (30) are identified by first marking the prime numbers identified thereon by connecting at least two subunits marked with a prime number. Marking the subunit with lower value prime number (P1) as the starting point of connection, marking the subunit with higher value prime number (P2) as the end point of the connection, and connecting them together by an object, a dotted or straight line or any combination thereof. In one preferred embodiment, the object is an image of an aeroplane.

The cognitive training device disclosed in the above aspects; also essentially contains an instrument to generate random numbers. This instrument may be able to count numbers from 1 to n². Further, a dice, a number coining machine, a spinning wheel marked with numbers, an electronic roller, a set of shuffling cards marked with numbers, manual lucky draw chits or a computer program resembling lottery system may be used as an instrument to generate random numbers.

One of the greatest challenges facing educators today is that of engaging a wide and diverse group of students. Students come to the learning experience with varying degrees of motivation, commitment, ability, and learning styles or approaches. Educational scientists have noted that regardless of age or economic, ethnic, or social background, people understand the language of uncertainty and anticipation. It is natural that best training environments have excitement and interactivity to support learning. Thus, the present invention uses an instrument to generate random numbers that contributes to creating the abovementioned learning experience. Therefore, any device to generate random numbers in the range defined may suffice. More particularly the range is 1 to n².

In another preferred embodiment, the method of using the cognitive training device is explained in the flow chart as described in FIG. 24. In this case the Home (31) is beyond the subunit marked by n\hat{ }2.

In another preferred embodiment, the method of using cognitive training device is explained in the flow chart as described in FIG. 25. In this case the Home (31) is beyond the subunit marked by a prime number specifically positioned at [x, 1], [x, n], [1, y], [n, y] wherein x and y vary from 1 to n. The objective is to increase the eagerness to learn as children in this age group lose interest in a couple of days. The new challenge will motivate them and thereby enhancing cognitive training.

In preferred embodiment, the playing board is made into a game adaptable in computing devices and the training and play is conducted on internet or other means by displaying the playing board on the monitor, a television screen, a mobile phone or other suitable device. The random numbers in the range of 1 to n² are generated by computing device.

Hereinafter, the invention is explained in detail in the following examples. These examples are provided with the intent of illustration only and therefore should not be construed to limit the scope of the invention in any way.

### EXAMPLE 1

A cognitive training device, for familiarizing squares, square roots and prime numbers in the range 1-100 is disclosed. The playing board in FIG. 12 has a matrix of 10×10 that divides the said playing board into 100 equal subunits ranging from [1, 1] to [10, 10].

Further, there is an anticlockwise path that starts from the center subunit denoted by 1 and end at the last subunit denoted by 100. Though in this particular example anti-clockwise path is adapted, in alternate arrangement the path can be clockwise also.

After the subunit denoted by 100 is the HOME which is not a part of the matrix. Along the path, every subunit is denoted by a particular number that is sequentially obtained while moving from the center subunit denoted by 1 to subunit 100 in a particular chosen direction such that the succeeding subunit is always adjacent to the preceding subunit and is also in the direction of the chosen path.

In this example the center is [5,5] and the path is anticlockwise. Thus, the sequential numbering of subunits along the said anticlockwise path from subunit 1 to 100 proceeds in this order : [5,5] [5,6] [6,6] [6,5] [6,4] [5,4] [4,4] [4,5] [4,6] [4,7] [5,7] [6,7] [7,7] [7,6] [7,5] [7,4] [7,3] [6,3] [5,3] [4,3] [3,3] [3,4] [3,5] [3,6] [3,7] [3,8] [4,8] [5,8] [6,8] [7,8] [8,8] [8,7] [8,6] [8,5] [8,4] [8,3] [8,2] [7,2] [6,2] [5,2] [4,2] [3,2] [2,2] [2,3] [2,4] [2,5] [2,6] [2,7] [2,8] [2,9] [3,9] [4,9] [5,9] [6,9] [7,9] [8,9] [9,9] [9,8] [9,7] [9,6] [9,5] [9,4] [9,3] [9,2] [9,1] [8,1] [7,1] [6,1] [5,1] [4,1] [3,1] [2,1] [1,1] [1,2] [1,3] [1,4] [1,5] [1,6] [1,7] [1,8] [1,9] [1,10] [2,10] [3,10] [4,10] [5,10] [6,10] [7,10] [8,10] [9,10] [10,10] [10,9] [10,8] [10,7] [10,6] [10,5] [10,4] [10,3] [10,2] [10,1].

Two parallel diagonals (28 & 28′) are identified. The parallel diagonal (28) has subunits marked with squares of even numbers (4, 16, 36, 64, and 100) and parallel diagonal (28′) has subunits marked with squares of odd numbers (9, 25, 49, and 81).

Pairs of square and square root (29) identified thereon by connecting a subunit marked with square to a subunit marked with their respective square root by an image of parachute positioned at the subunit marked by the square and is connected by a line to the subunit marked by the respective square root; more particularly connecting subunit 4 to 2, subunit 9 to 3, subunit 16 to 4, subunit 25 to 5, subunit 36 to 6, subunit 49 to 7, subunit 64 to 8 subunit 81 to 9 and subunit 100 to 10.

Further, the subunits on the playing board denoted by a prime number (P1) is connected to another subunit also denoted by another prime number (P2) wherein lower value prime number is denoted as P1 for each connection. This connection is made by a flight such that it may be boarded from the subunit denoted by the lower value prime number (P1). More particularly, flight connections are from subunit 2 (P1) to subunit 7 (P2), subunit 7 (P1) to subunit 23 (P2), subunit 23 (P1) to subunit 47 (P2), subunit 47 (P1) to subunit 79 (P2), subunit 3 (P1) to subunit 13(P2), subunit 13 (P1) to subunit 31 (P2), subunit 37 (P1) to subunit 67 (P2), subunit 61 (P1) to subunit 97 (P2), subunit 11 (P1) to subunit 29 (P2), subunit 29 (P1) to subunit 53 (P2), subunit 53 (P1) to subunit 83 (P2), subunit 59 (P1) to subunit 89 (P2), subunit 5 (P1) to subunit 19 (P2), subunit 19 (P1) to 41 (P2), subunit 41 (P1) to subunit 71 (P2), and subunit 43 (P1) to subunit 73 (P2). Thus, multiple pairs (30) are marked.

The counting instrument to generate random numbers used in this example is lottery cards ranging from 1-25. The differentiating marker piece used is a game piece.

### EXAMPLE 2

A cognitive training device, for familiarizing squares, square roots and prime numbers in the range 1-81 is disclosed in FIG. 21. The rectangular playing board (2) in FIG. 21 having a matrix of 9×9 that divides the said playing board into 81 equal subunits ranging from [1, 1] to [9, 9] is disclosed. Further, two parallel diagonals (28,28′) incorporating within them the squares of even numbers ranging from 2 to 8 and squares of odd numbers ranging from 1 to 9 respectively is shown. All pairs of square and square root (29) are marked in FIG. 21. Multiple pairs of prime numbers (30) by connecting the subunits marked with prime number are also marked in FIG. 21.

In this case, game pieces were used as differentiating marker pieces. Further, it also has an instrument to generate random numbers wherein a number coining device was used. In this example the center subunit marked by 1 is positioned at [5, 5] and the subunit marked by 2 is positioned at [5, 6]. Further, the path is anticlockwise.

Thus, the rectangular playing board has 81 subunits (21) ranging from [1, 1] to [9, 9] and marked thereon an anticlockwise (22) starting from a center marked by number 1 positioned on a subunit [5, 5] (23) and ending on a corner marked by number 81 positioned on another subunit (26) by encompassing the remaining subunits sequentially numbered from 2 to 80 as disclosed in FIGS. 8 and 9. Though in this particular example anti-clockwise path is adapted, in alternate arrangement the path can be clockwise also.

Two parallel diagonals (28,28′) incorporating within them the squares of even numbers ranging from 2 to 8 and squares of odd numbers ranging from 1 to 9 respectively is shown. The pairs of square and square root (29) are marked in FIG. 21. Multiple pairs of prime numbers (30) by connecting the subunits marked with prime number are marked in FIG. 21.

I claim:

1. A cognitive training and play device (1), for familiarizing squares, square roots and prime numbers by the players, comprising:
a rectangular playing board (2) for use as a playing surface by the players, having marked thereon,
a matrix of n×n dividing the said playing board into n² subunits (21) ranging from [1, 1] to [n, n], wherein n is an even number, and marked thereon an anticlockwise or clockwise path (22) starting from a center marked by number 1 positioned on a subunit (23) and ending on a corner marked by number n² positioned on another subunit (26) by encompassing the remaining subunits sequentially numbered from 2 to (n²−1) in it such that the sequentially numbered succeeding subunit is always adjacent to the sequentially numbered preceding subunit and is also in the direction of the said path, provided that—
when the path is marked in clockwise direction then the path start is positioned on a subunit (23) selected from [n/2, n/2], [(n/2)+1, n/2], [n/2, (n/2)+1] and [(n/2)+1, (n/2)+1] and the path end is positioned on a corresponding subunit (26) positioned at [1, n], [1, 1], [n, n] and [n, 1] respectively, and when the path is marked in anticlockwise direction then the path start is positioned on a subunit (23) selected from [n/2, n/2], [(n/2)+1, n/2], [n/2, (n/2)+1] and [(n/2)+1, (n/2)+1] and the path end is positioned on the a subunit (26) positioned at [n, 1], [n, n], [1, 1] and [1, n]; number 2 is essentially marked on a subunit (24) selected from [n/2, n/2], [(n/2)+1, n/2], [n/2, (n/2)+1] or [(n/2)+1, (n/2)+1] excluding the subunits (23); number 3 is essentially marked on a subunit (25) selected from [n/2, n/2], [(n/2)+1, n/2], [n/2, (n/2)+1] and [(n/2)+1, (n/2)+1] excluding the subunits (23), and the subunit marked with 2, and after positioning the subunits marked with the numbers 1 to 3 on the board the path turns 90 degrees at several subunits (27) to follow either clockwise or anticlockwise direction till reaching its ending subunit (26), first being at a subunit denoted by 3 and travel further till 2 subunits, then at a subunit denoted by 5 and travel further till 2 subunits, and subsequently take two consecutive turns at every three subunits, then at every four subunits, and follows this two times turning pattern sequentially for five, six and so on subunits while travelling further and reaching to the ending subunit (26);
two parallel diagonals (28, 28′) incorporating within them the squares of even numbers ranging from 2 to n and squares of odd numbers ranging from 1 to (n−1) respectively;
pairs of square and square root (29) by connecting a subunit marked with square to a subunit marked with its respective square root; and
multiple pairs of prime numbers (30) by connecting the subunits marked with a prime number;
a set of differentiating marker pieces for identifying the players of the cognitive training and play device; and
an instrument to generate random numbers preferably in the range of 1 to n².

2. A cognitive training and play device (1), for familiarizing squares, square roots and prime numbers by the players, comprising:
a rectangular playing board (2) for use as a playing surface by the players, having marked thereon,
a matrix of n×n dividing the said playing board into n² subunits (21) ranging from [1, 1] to [n, n], wherein n is an odd number, and marked thereon an anticlockwise or clockwise path (22) starting from a center marked by number 1 positioned on a subunit [n+1/2, n+1/2] (23) and ending on a corner marked by number n²positioned on another subunit (26) by encompassing the remaining subunits sequentially numbered from 2 to (n²−1) in it such that the sequentially numbered succeeding subunit is always adjacent to the sequentially numbered preceding subunit and is also in the direction of the said path, provided that—
when the path is marked in clockwise direction then number 2 is essentially marked on a subunit (24) selected from [(n+3)/2, (n+1)/2], [(n+1)/2, (n+3)/2], [(n−1)/2, (n+1)/2] and [(n+1)/2, (n−1)/2] and the path end is positioned on a corresponding subunit (26) positioned at [n, 1], [n, n], [1, n] and [1, 1] respectively, and when the path is marked in anticlockwise direction then number 2 is essentially marked on a subunit (24) selected from [(n+3)/2, (n+1)/2], [(n+1)/2, (n+3)/2], [(n−1)/2, (n+1)/2] and [(n+1)/2, (n−1)/2] and the path end is positioned on a corresponding subunit (26) positioned at [n, n], [1, n], [1, 1] and [n, 1] respectively; number 3 is essentially marked on a subunit (25) selected from[(n+3)/2, (n+3)/2], [(n−1)/2, (n+3)/2], [(n−1)/2, (n−1)/2] and [(n+3)/2, (n−1)/2], and after positioning the subunits marked with the numbers 1 to 3 on the board the path turns 90 degrees at several subunits (27) to follow either clockwise or anticlockwise direction till reaching its ending subunit (26), first being at a subunit denoted by 3 and travel further till 2 subunits, then at a subunit denoted by 5 and travel further till 2 subunits, and subsequently take two consecutive turns at every three subunits, then at every four subunits, and follows this two times turning pattern sequentially for five, six and so on subunits while travelling further and reaching to the ending subunit (26),
two parallel diagonals (28, 28′) incorporating within them the squares of even numbers ranging from (2 to n−1) and squares of odd numbers ranging from 1 to (n−1) respectively,
pairs of square and square root (29) by connecting a subunit marked with square to a subunit marked with its respective square root, and
multiple pairs of prime numbers (30) by connecting the subunits marked with a prime—number;
a set of differentiating marker pieces for identifying the players of the cognitive training and play device; and
an instrument to generate random numbers preferably in the range of 1 to n².

3. A cognitive training and play device (1), for familiarizing squares, square roots and prime numbers by the players, comprising:
a rectangular playing board (2) for use as a playing surface by the players, having marked thereon,
a matrix of 10×10 dividing the said playing board into 100 subunits (21) ranging from [1, 1] to [10, 10], and marked thereon an anticlockwise or clockwise path (22) starting from a center marked by number 1 positioned on a subunit (23) and ending on a corner marked by number 100 positioned on another subunit (26) by encompassing the remaining subunits sequentially numbered from 2 to 99 in it such that the sequentially numbered succeeding subunit is always adjacent to the sequentially numbered preceding subunit and is also in the direction of the said path, provided that—
when the path is marked in clockwise direction then the path start is positioned on a subunit (23) selected from [5, 5], [6, 5], [5, 6] and [6, 6] and the path end is positioned on a corresponding subunit (26) positioned at [1, 10], [1, 1], [10, 10] and [10, 1] respectively, and when the path is marked in anticlockwise direction then the path start is positioned on a subunit (23) selected from [5, 5], [6, 5], [5, 6] and [6, 6] and the path end is positioned on the a subunit (26) positioned at [10, 1], [10, 10], [1, 1] and [1, 10]; number 2 is essentially marked on a subunit (24) selected from [5, 5], [6, 5], [5, 6] and [6, 6] excluding the subunits (23); number 3 is essentially marked on a subunit (25) selected from [5, 5], [6, 5], [5, 6] and [6, 6] excluding the subunits (23), and the subunit marked with 2, and after positioning the subunits marked with the numbers 1 to 3 on the board the path turns 90 degrees at several subunits (27) to follow either clockwise or anticlockwise direction till reaching its ending subunit (26), first being at a subunit denoted by 3 and travel further till 2 subunits, then at a subunit denoted by 5 and travel further till 2 subunits, and subsequently take two consecutive turns at every three subunits, then at every four subunits, and follows this two times turning pattern sequentially for five, six and so on subunits while travelling further and reaching to the ending subunit (26),
two parallel diagonals (28, 28′) incorporating within them the squares of even numbers ranging from 2 to 10 and squares of odd numbers ranging from 1 to 9 respectively,
pairs of square and square root (29) by connecting a subunit marked with square to a subunit marked with its respective square root, and
multiple pairs of prime numbers (30) by connecting the subunits marked with a prime number;
a set of differentiating marker pieces for identifying the players of the cognitive training and play device; and
an instrument to generate random numbers preferably in the range of 1 to 100.

4. (canceled)

5. The cognitive training and play device (1) as claimed in claims 1, wherein multiple pairs of prime numbers (30) are identified by first marking the subunit with lower value prime number (P1) as the starting point of connection, marking the subunit with higher value prime number (P2) as the end point of the connection, and connecting them together by an object, a dotted or straight line or any combination thereof.

6. The cognitive training and play device (1) as claimed in claim 5, wherein the connection is the combination of an object and a dotted or straight line.

7. The cognitive training and play device (1) as claimed in claim 6, wherein the object is an image of an aeroplane.

8. The cognitive training and play device (1) as claimed in claim 3, wherein multiple pairs of prime numbers (30) are identified by first marking the subunit with lower value prime number (P1) as the starting point of connection, marking the subunit with higher value prime number (P2) as the end point of the connection, more particularly connecting subunit 2 to subunit 7, subunit 7 to subunit 23, subunit 23 to subunit 47, subunit 47 to subunit 79, subunit 3 to subunit 13, subunit 13 to subunit 31, subunit 37 to subunit 67, subunit 61 to subunit 97, subunit 11 to subunit 29, subunit 29 to subunit 53, subunit 53 to subunit 83, subunit 59 to subunit 89, subunit 5 to subunit 19, subunit 19 to 41, subunit 41 to subunit 71, and subunit 43 to subunit 73.

9. The cognitive training and play device (1) as claimed in claims 1, wherein two parallel diagonals (28, 28′) incorporating within them the squares of even numbers and odd numbers are identified and marked by objects, dotted or straight lines or any combination thereof.

10. The cognitive training and play device (1) as claimed in claim 1, wherein the pairs of square and square root (29) are marked by first marking the subunit with square as the starting point of connection and marking the subunit with its respective square root as the end point of the connection, then connecting them together by an object, a dotted or straight line or any combination thereof.

11. The cognitive training and play device (1) as claimed in claim 10, wherein the connection is the combination of an object and a dotted or straight line.

12. The cognitive training and play device as claimed in claim 9, wherein the object is an image of a parachute.

13. The cognitive training and play device (1) as claimed in claim 3, wherein the pairs of square and square root (29) are marked by first marking the subunit with square as the starting point of connection, marking the subunit with its respective square root as the end point of the connection; more particularly connecting subunit 4 to 2, subunit 9 to 3, subunit 16 to 4, subunit 25 to 5, subunit 36 to 6, subunit 49 to 7, subunit 64 to 8, subunit 81 to 9 and subunit 100 to 10.

14. The cognitive training and play device (1) as claimed in claim 1, wherein the instrument to generate random numbers (3) is selected from a dice, a number coining machine, a spinning wheel marked with numbers, an electronic roller, a set of shuffling cards marked with numbers, manual lucky draw chits or a computer program resembling lottery system.

15. The cognitive training and device as claimed in claim 1, further comprising an instructional manual specifying the logical structure of the game, the ordering of the differentiating marker pieces on the surface of the playing board and rules that govern the start and the end of the training session.

16. The cognitive training and play device (1) as claimed in claim 1, wherein the playing board is made into a game adaptable in computing devices and the training and play is conducted on internet or other means by displaying the playing board on the monitor, a television screen, a mobile phone or other suitable device.

17. The cognitive training and play device (1) as claimed in claim 16, wherein the random numbers in the range of 1 to n² are generated by computing device.
